(19) United States
(12) Patent Application Publication
(10) Pub. No.: US 2022/0388924 A1
(43) Pub. Date: Dec. 8, 2022

(54) DUST SUPPRESSANT AND ANTI-CAKING COATING FOR HYGROSCOPIC SUBSTRATES

(71) Applicant: ArrMaz Products Inc., Mulberry, FL (US)

(72) Inventors: Mark Ogzewalla, Winter Haven, FL (US); Lucas Moore, Dover, FL (US); Jessica Quinn, Lakeland, FL (US)

(73) Assignee: ArrMaz Products Inc., Mulberry, FL (US)

(21) Appl. No.: 17/684,946

(22) Filed: Mar. 2, 2022

Related U.S. Application Data
(60) Provisional application No. 63/156,015, filed on Mar. 3, 2021.

(51) Int. Cl. C05F 11/00

(52) U.S. Cl. CPC C05F 11/00

(57) ABSTRACT

A fertilizer coating providing effective dust control and caking reduction properties while maintaining organic farming standards. The coating may comprise a combination of highly saturated triglycerides, such as palm stearin, and plant-based oil and/or lecithin, such as soybean oil and/or soy lecithin. The coating may further comprise gum derived from plants, such as fenugreek gum.

### CROSS REFERENCE

This application is based on and claims priority to U.S. Provisional Patent Application No. 63/156,015 filed Mar. 3, 2021.

### BACKGROUND OF THE INVENTION

### Field of the Invention

This invention relates generally to coatings, and more particularly, but not by way of limitation, to a dust suppressant and anti-caking coating for hygroscopic substrates.

### DESCRIPTION OF THE RELATED ART

Plants require a wide range of nutrients for optimal crop growth and fruit production. Nutrients come from the air or through adsorption through the root. Continuously farmed soils become depleted of essential nutrients. To maintain soil fertility and maximize crop production, nutrients must be added by the way of fertilizers. Solid fertilizers are typically hygroscopic and are often very dusty. As such, fertilizers benefit from the application of coatings that control dust and reduce caking, or loss of granule integrity due to excess moisture absorption.

Synthetic materials are not allowed under organic farming principals and, as such, many common fertilizers do not qualify for use. The fertilizers that are allowed in organic farming are thus unique and any coating agent applied to them must retain that status.

It has long been known that hydrophobic materials can be applied as coating to reduce dust and minimize caking. Coating agents on the market, however, are synthetic and thus not allowed in organic farming or they do not perform well as both dust control and anti-caking agents on hygroscopic substrates.

Based on the foregoing, it is desirable to provide a coating with effective dust control and anti-caking properties while maintaining organic farming standards.

In particular, it is desirable for the coating to be non-synthetic and able to evenly and effectively coat the substrate with a hydrophobic film.

### SUMMARY OF THE INVENTION

In general, in a first aspect, the invention relates to a fertilizer coating comprising highly saturated triglycerides and plant-based oil and/or lecithin. The fertilizer coating may further comprise gum derived from plants.

The highly saturated triglycerides may comprise palm stearin, or other highly saturated triglycerides such as butter, lard, animal fats, palm oil, palm wax, coconut oil, coco butter, etc. The plant-based oil and/or lecithin may comprise soybean oil and/or soy lecithin, or other plant-based oil and/or lecithin such as sunflower oil or lecithin, canola oil or lecithin, palm olein, etc. The gum may comprise fenugreek gum, locust bean gum, carob gum, tragacanth gum, gum ghatti, mucilage gums, guar gum, or any other polysaccharides produced from plants. Other gums may include xantham gum, dextran, welan gum, gellan gum, diutan gum, pulluan, etc. or other polysaccharides, such as pectins, chitin, cellulose, etc.

The fertilizer coating may comprise 5% to 50% palm stearin, 0% to 95% lecithin, and 0% to 20% polysaccharide gum. Specifically, the fertilizer coating may comprise 35% palm stearin, 60% soy bean oil, and 5% polysaccharide gum. Alternately, the fertilizer coating may comprise 50% palm stearin and 50% crude soybean oil. Alternately, the fertilizer coating may comprise 95% lecithin and 5% polysaccharide gum.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a family of coatings that provides effective dust control and caking reduction properties while maintaining organic farming standards. The non-synthetic nature of the coating combined with its ability to evenly and effectively coat the substrate with a hydrophobic film is unique.

The coating of the present invention may comprise a combination of one or more highly saturated triglycerides and vegetable oil and/or vegetable lecithin. In particular, the coating may comprise a combination of palm stearin and lecithin and/or soybean oil. The coating may further comprise polysaccharide gum or other gum derived from plants, which may particularly be fenugreek gum. The coating may additionally comprise other components.

The palm stearin may provide excellent hydrophobic properties. The high degree of saturation of the triglycerides in the palm stearin combined with low fatty acid content may be the key to its effectiveness. Palm stearin appears to work better than saturated fatty acids and is non-synthetic. Saturated fatty acids, like stearic acid, are considered synthetic since they have been chemically split from a triglyceride molecule. Other highly saturated triglycerides, such as butter, lard, animal fats, palm oil, palm wax, coconut oil, coco butter, etc., are likely substitutes for palm stearin, but have not been identified. Other vegetable oils may be used as substitutes for soybean oil, such as sunflower, canola, palm olein, etc. Maintaining a high percentage of highly saturated triglyceride in the formulation may be needed to maintain maximum anti-caking performance.

Lecithin may improve coating handling, spread-ability, and stability. Its amphiphilic nature may also improve anticaking and dust control properties. Soy lecithin is readily available, but other sources of lecithin, such as sunflower, rapeseed, cottonseed, etc., could be used as substitutes.

Fenugreek gum (polysaccharide gum), also known as Greek hay, may provide an additional level of improvement in anti-caking. Alternately, the gum may comprise locust bean gum, carob gum, tragacanth gum, gum ghatti, mucilage gums, guar gum, or any other polysaccharides produced from plants. Other polysaccharide gums, such as xantham gum, dextran, welan gum, gellan gum, diutan gum, pulluan, etc., or other polysaccharides, such as pectins, chitin, cellulose, etc., could be used as substitutes. Most of these polysaccharides exhibit useful visco-elastic properties when dissolved in water at very low levels.

In particular, the coating may comprise 7% to 50% highly saturated triglycerides and 12% to 65% plant-based oil and/or lecithin. The coating may additionally comprise 5% gum, such as polysaccharide gum or, specifically, fenugreek gum. For example, the coating may comprise 35% palm stearin, 60% soy bean oil, and 5% polysaccharide gum. In another example, the coating may comprise 50% palm stearin and 50% crude soybean oil. In an additional example, the coating may comprise 57% lecithin, 7% palm stearin, 12% soy bean oil, and 5% polysaccharide gum. Alternately, the coating may comprise just highly saturated triglycerides without plant-based oil or lecithin or just plant-based oil and/or lecithin without highly saturated triglycerides, either with or without 5% gum. For example, the coating may comprise 95% lecithin and 5% polysaccharide gum.

Applying an effective coating which is organic farming-approved to fertilizer inputs allowed under organic farming principals may maintain the unique status of those fertilizer inputs, while controlling dust generation, improving moisture uptake, and controlling caking tendencies.

### Example 1

Coatings containing 35% to 100% palm stearin, with the balance being soybean oil, were prepared and tested for anti-caking effectiveness and dust control. These coatings were compared to the standard non-organic farming coating consisting of mineral oil (lube oil) and 10% stearyl amine.

The palm stearin-based coatings were applied to compacted red potash (KCl) granules and evaluated for caking tendencies and dust generation. The results from selected testing are summarized in the following graphs and table.

Formulations tested are shown in the following table.

| | | | Caking |
|---|---|---|---|
| | | Percent by | Reduction |
| Blend | Raw Material | weight (%) | (%) |
| CEB7-83-1 | Triglyceride 1 | 35 | 83 |
| | Plant Oil 1 | 65 | |
| CEB7-86-1 | Non-organic | | 61 |
| CEB7-87-4 | Triglyceride 2 | 100 | 72 |
| CEB7-87-5 | Lecithin 1 | 100 | 43 |
| CEB7-87-6 | Plant Oil 1 | 100 | 6 |
| CEB7-87-7 | Triglyceride 2 | 5 | 65 |
| | Plant Oil 1 | 95 | |
| CEB7-87-8 | Triglyceride 2 | 10 | 51.0 |
| | Plant Oil 1 | 90 | |
| CEB7-87-9 | Triglyceride 2 | 20 | 78.0 |
| | Plant Oil 1 | 80 | |
| CEB7-87-10 | Triglyceride 2 | 50 | 77.0 |
| | Plant Oil 1 | 50 | |
| CEB7-87-11 | Triglyceride 2 | 20 | 57.0 |
| | Lecithin 1 | 80 | |
| CEB7-87-12 | Triglyceride 2 | 34 | 54.0 |
| | Plant Oil 1 | 33 | |
| | Lecithin 1 | 33 | |
| CEB7-87-13 | Proprietary Formulation | | 48.0 |
| CEB7-87-14 | Triglyceride 2 | 20 | 51 |
| | Plant Oil 1 | 40 | |
| | Lecithin 1 | 40 | |
| CEB7-87-15 | Triglyceride 2 | 35 | 69.0 |
| | Plant Oil 2 | 65 | |

| | | |
|---|---|---|
| CEB7-87-16 | Proprietary Formulation | 40.0 |
| CEB7-87-17 | Proprietary Formulation | 42.0 |
| CEB8-7-1 | Non-organic | 90 |
| CEB8-9-4 | Proprietary Formulation | 43 |

The cake strength was reduced with the organic farming coating. Caking was reduced by more than 80%. The initial dust reduction observed for the organic farming coating was 89% compared to the non-organic farming coating at 93%. These numbers are comparable and within the testing error.

### Example 2

Coatings based on the previous example were prepared but with the addition of fenugreek gum. It was found that a 5% addition of fenugreek gum (polysaccharide gum) may yield significant improvements in the caking of polyhalite. The following chart shows the caking and moisture reduction of potassium-based substrates, as a function of the coating.

Formulations tested are shown in the following table.

| | | | Moisture | Caking |
|---|---|---|---|---|
| | | Percent by | Reduction | Reduction |
| Blend | Raw Material | weight (%) | (%) | (%) |
| JQ061819-1 | Triglyceride 2 | 35 | 0.6 | 61 |
| | Plant Oil 1 | 65 | | |
| JQ061819-4 | Triglyceride 2 | 35 | -2.6 | 67 |
| | Lecithin 1 | 65 | | |
| JQ061819-5 | Triglyceride 2 | 35 | 0.1 | 75 |
| | Plant Oil 1 | 32.5 | | |
| | Lecithin 1 | 32.5 | | |
| JQ070219-3 | Plant Oil 2 | 100 | 1.5 | 38 |
| JQ071019-1 | Lecithin 1 | 60 | | |
| | Polysaccharide | 5 | 22.7 | 82 |
| | Gum 1 | | | |
| | Triglyceride 2 | 35 | | |
| JQ071019-2 | Plant Oil 1 | 30 | 26.6 | 70 |
| | Lecithin 1 | 30 | | |
| | Polysaccharide | 5 | | |
| | Gum 1 | | | |
| | Triglyceride 2 | 35 | | |
| JQ071519-1 | Triglyceride 1 | 100 | 10.2 | 75 |
| JQ071519-4 | Triglyceride 1 | 35 | 9.1 | 85 |
| | Lecithin 1 | 65 | | |
| JQ071519-5 | Triglyceride 1 | 35 | 8.6 | 82 |
| | Plant Oil 1 | 32.5 | | |
| | Lecithin 1 | 32.5 | | |
| JQ072919-1 | Triglyceride 1 | 50 | 19.5 | 50 |
| | Lecithin 1 | 50 | | |
| JQ073019-1 | Triglyceride 1 | 35 | 17.6 | 40 |
| | Plant Oil 1 | 60 | | |
| | Polysaccharide | 5 | | |
| | Gum 1 | | | |
| JQ073019-2 | Triglyceride 1 | 35 | 6.3 | 29 |
| | Lecithin 1 | 60 | | |
| | Polysaccharide | 5 | | |
| | Gum 1 | | | |
| JQ073019-3 | Triglyceride 1 | 35 | 10.7 | 81 |
| | Plant Oil 1 | 30 | | |
| | Lecithin 1 | 30 | | |
| | Polysaccharide | 5 | | |
| | Gum 1 | | | |
| JQ073019-4 | Triglyceride 1 | 50 | 12.4 | 63 |
| | Lecithin 1 | 45 | | |
| | Polysaccharide | 5 | | |
| | Gum 1 | | | |
| JQ073019-5 | Triglyceride 1 | 50 | 13.8 | 72 |
| | Plant Oil 1 | 45 | | |
| | Polysaccharide | 5 | | |
| | Gum 1 | | | |
| CEB7-83-1 | Triglyceride 1 | 35 | 33.3 | 44 |
| | Plant Oil 1 | 65 | | |
| CEB7-87-4 | Triglyceride 2 | 100 | 5.1 | 44 |
| CEB7-87-5 | Lecithin 1 | 100 | 3.7 | 60 |
| CEB7-87-6 | Plant Oil 1 | 100 | 3.2 | 23 |
| CEB7-87-10 | Triglyceride 2 | 50 | -0.9 | 78 |
| | Plant Oil 1 | 50 | | |
| CEB7-87-15 | Triglyceride 2 | 35 | 2.0 | 88 |
| | Plant Oil 2 | 65 | | |
| CEB7-88-6 | Polysaccharide | 5 | 26.2 | 76 |
| | Gum 1 | | | |
| | Lecithin 1 | 95 | | |
| CEB7-88-7 | Plant Oil 1 | 60 | 26.1 | 87 |
| | Polysaccharide | 5 | | |
| | Gum 1 | | | |
| | Triglyceride 2 | 35 | | |
| CEB7-88-8 | Triglyceride 1 | 50 | 24.5 | 67 |
| | Plant Oil 1 | 50 | | |

Whereas, the devices and methods have been described in relation to the drawings and claims, it should be understood that other and further modifications, apart from those shown or suggested herein, may be made within the spirit and scope of this invention.

What is claimed is:

1. A fertilizer coating comprising:
highly saturated triglycerides; and
plant-based oil and/or lecithin.

2. The fertilizer coating of claim 1 further comprising gum derived from plants.

3. The fertilizer coating of claim 1 where the highly saturated triglycerides comprise palm stearin.

4. The fertilizer coating of claim 1 where the plant-based oil and/or lecithin comprises plant oil and/or lecithin.

5. The fertilizer coating of claim 2 where the gum comprises polysaccharide gum.

6. The fertilizer coating of claim 1 where:
the highly saturated triglycerides are palm stearin and comprise 0% to 50% of the fertilizer coating;
the plant-based oil and/or lecithin is lecithin and comprises 0% to 95% of the fertilizer coating; and
the fertilizer coating further comprises 0% to 20% polysaccharide gum.

7. The fertilizer coating of claim 1 where:
the highly saturated triglycerides are palm stearin and comprise 35% of the fertilizer coating;
the plant-based oil and/or lecithin is soy bean oil, sunflower oil, palm oil, or any other oil naturally derived from plants and comprises 60% of the fertilizer coating; and
the fertilizer coating further comprises 5% polysaccharide gum.

8. The fertilizer coating of claim 1 where:
the highly saturated triglycerides are palm stearin and comprise 50% of the fertilizer coating; and
the plant-based oil and/or lecithin is soybean oil and comprises 50% of the fertilizer coating.

9. The fertilizer coating of claim 1 where:
the plant-based oil and/or lecithin is lecithin and comprises 95% of the fertilizer coating; and
the fertilizer coating further comprises 5% polysaccharide gum.

10. The fertilizer coating of claim 1 where:
the highly saturated triglycerides are palm stearin and comprise 7% to 14% of the fertilizer coating;
the plant-based oil and/or lecithin is lecithin and comprises 57% to 76% of the fertilizer coating;
the plant-based oil and/or lecithin is soy bean oil and comprises 12% to 24% of the fertilizer coating; and
the fertilizer coating further comprises 5% polysaccharide gum.
